(19) United States
(12) Patent Application Publication
(10) Pub. No.: US 2006/0027276 A1
(43) Pub. Date: Feb. 9, 2006

(54) Seamless inflatable bag with multiple applications

(76) Inventor: Alford Main, North Richland Hills, TX (US)

Correspondence Address: DECKER, JONES, MCMACKIN, MCCLANE, HALL &;BATES, P.C., BURNETT PLAZA 2000, 801 CHERRY STREET, UNIT #46, FORT WORTH, TX, 76102-6836, US

(21) Appl. No.: 10/965,614

(22) Filed: Oct. 14, 2004

Related U.S. Application Data
(60) Provisional application No. 60/512,670, filed on Oct. 20, 2003.
(60) Provisional application No. 60/569,799, filed on May 10, 2004.

(51) Int. Cl. F16L 55/12

(52) U.S. Cl. 138/93

(57) ABSTRACT

A seamless inflatable bag is made with two layers, namely an outer layer made of a woven material such as from p-aramid and an inner gas proof layer. The outer edges of the layers are brought together around a tube and secured in place by a sleeve that is crimped in place such that the outer edges are interposed between the sleeve and the tube. A second sleeve can be crimped on to the first sleeve for further strength. This arrangement provides an airtight seal, wherein fluids such as gas or liquid can be provided to the interior of the bag to inflate the bag upon command. The bag can be used to lift objects such as in place of a vehicle jack or can be used to plug a pipe. To inflate the bag, an air compressor provides compressed air to the interior of the bag. To deflate the bag, the compressed air is bled away from the bag.

This application claims the benefit of U.S. Provisional Application Nos. 60/512,670, filed Oct. 20, 2003 and 60/569,799, filed May 10, 2004.

### FIELD OF THE INVENTION

The present invention relates to inflatable bags, which bags can be used for plugs for pipes, such as water lines, and also for lifting or prying objects.

### BACKGROUND OF THE INVENTION

Water pipes occasionally require repair or maintenance. For example, an old pipe may break, resulting in water leaking out of the break. Alternatively, a new tap may need to be added to an existing line, so as to supply new real estate developments.

Repairing or maintaining a water pipe requires isolating the section around the break or tap from the water supply. Once isolated, the break can be repaired and the tap can be made.

Prior art isolation techniques involve installing temporary cut-in gate valves. The valves are installed in-line with the pipe. Installing gate valves is expensive and time consuming.

Also, in the prior art are soft rubber or folding plugs that are inserted into the pipe and pressed or unfolded to plug the pipe. These prior art plugs are expensive and are difficult to insert into the pipe. With sewer pipes, which are not pressurized as are water pipes, sewer plugs are inserted and inflated to a low pressure.

There is a need for an inexpensive, durable and reliable plug for use in water lines and sewers.

Still another problem involves lifting vehicles. Vehicle jacks are typically of either the scissors type or of the jack stand type. The jack has a small base and a lifting section that fits beneath the vehicle chassis. Vehicle jacks are heavy and can be difficult to use for people with limited mechanical experience. In addition, the jacks are so specialized that they cannot typically be used for non-vehicle lifting operations. For a lifting operation not involving a vehicle, another jack must be used.

Inflatable lifts can be used in a wide variety of applications, both vehicular and non-vehicular, and are relatively simple to understand and use. In the prior art, there are a number of inflatable lifts. These prior art lifts are made of rubber and are consequently expensive and very heavy.

### SUMMARY OF THE INVENTION

It is an object of the present invention to provide a seamless, inflatable bag that is inexpensive.

It is a further object of the present invention to provide a method and apparatus for installing a plug into a pipe in an inexpensive and time efficient manner.

It is a further object of the present invention to provide a lifting bag that is seamless and inexpensive.

The apparatus is for expanding between two points, and comprises an inner layer that is gas proof and an outer layer that is made of a woven material. The inner and outer layers are adjacent to one another so as to form a flexible wall having at least one edge around a central portion. The flexible wall is seamless. The edge is gathered and located around a tube so as to form an inner chamber that is lined by the inner layer. A sleeve is located around the gathered edge and crimped in place to secure the gathered edge, with the tube providing communication between the inner chamber and exterior of the bag. The bag has two ends when deflated, with the tube being located at one end and the central portion being located at the other end.

In accordance with one aspect of the present invention, the outer layer comprises p-aramid material.

In accordance with another aspect of the present invention, the inner and outer layers are separate from each other.

In accordance with still another aspect of the present invention, the sleeve is a first sleeve, the first end has a free end and a bag end and the bag further comprises a second sleeve that is shorter in length than the first sleeve. The second sleeve is located around the first sleeve so as to leave the free end of the first sleeve exposed.

In accordance with another aspect of the present invention, the inner and outer layers are circular when laid flat.

In accordance with still another aspect of the present invention, the apparatus includes an air compressor and a relief valve connected to the tube.

The present invention also provides a method of constructing an inflatable, expandable bag. A flexible material having a gas proof liner and a woven protective layer is provided. The material has a central portion and an edge at a perimeter of the material. A tube is wrapped with the edge so as to encircle the tube and form a bag with an inner chamber that is lined by the gas proof liner. The protective layer is on an exterior of the bag. A sleeve is placed over the material so that the material is interposed between the tube and the sleeve. The sleeve is crimped on to the material.

In accordance with one aspect of the present invention, the sleeve is a first sleeve and the method further comprises placing a second sleeve over the crimped first sleeve so as to leave uncovered a portion of the first sleeve, the second sleeve is located between the uncovered first sleeve portion and the central portion. The second sleeve is then crimped.

The present invention also provides a method of moving an object that is spaced from a reference by a distance. A seamless inflatable bag that is made of a protective outer material having a central portion and edges is provided. The edges are located around an access port with the access port being at one end of the bag and the central portion being at the other end of the bag. The edges are secured around the access port by a crimped sleeve. The bag is located between the object and the reference so that the access port is accessible and the outer material of the bag will contact the object and the reference upon inflation of the bag. The bag is inflated at the access port so that the bag outer material contacts both the object and the reference. Continued inflation is provided to the bag until the distance between the object and the reference increases.

The present invention also provides a method of plugging a pipe with the pipe having an inside diameter. A seamless inflatable bag made of a protective outer material having a central portion and edges is provided. The edges are located around an access port with the access port being at one end of the bag and the central portion being at another end of the bag. The bag having sides extending between the edges. The edges are secured around the access port by a crimped sleeve. The other end of the bag is inserted into the pipe and the bag is inflated through the access port so that the bag sides contact the pipe inside diameter, thereby plugging the pipe.

### BRIEF DESCRIPTION OF THE DRAWINGS

FIG. 1 is an isometric exploded view showing some of the components of the bag of the present invention, in accordance with a preferred embodiment.

FIG. 2 is an exploded side view of the bag.

FIG. 3 is a detail view of the tube end of the bag, after assembly.

FIG. 4 is a schematic elevational view of the lifting bag and inflation equipment, with the bag being positioned beneath an object prior to lifting.

FIG. 5 is a schematic elevational view of the lifting bag of FIG. 4, with the lifting bag inflated and the object lifted.

FIGS. 6A-6E show the lifting bag in accordance with another embodiment, wherein the bag has a large opening.

FIG. 7 is a side view of the plug after assembly.

FIGS. 8-11 are longitudinal cross-sectional views of the insertion tool, shown installed onto a pipe, with the plug located therein. FIG. 8 shows the plug before insertion. FIG. 9 shows an intermediate step of insertion. FIG. 10 shows the deflated plug bag inserted into the pipe and FIG. 11 shows the plug fully inflated in the pipe.

FIG. 12 is an exploded view of a plug, in accordance with another embodiment.

FIG. 13 is a cross-sectional view of a pipe embodiment showing the plug of FIG. 12.

### DESCRIPTION OF THE PREFERRED EMBODIMENTS

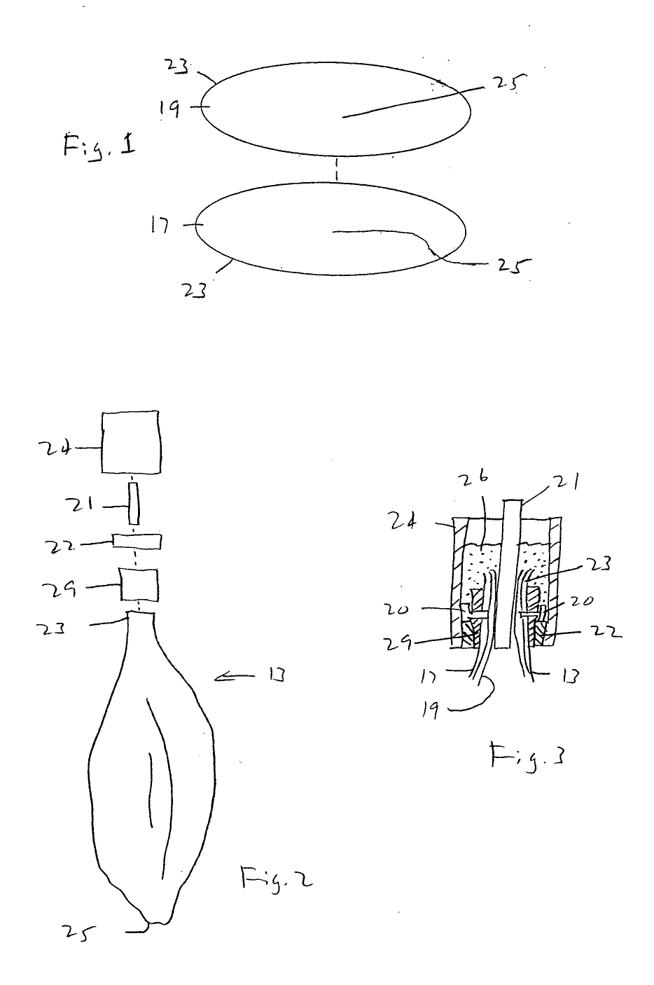

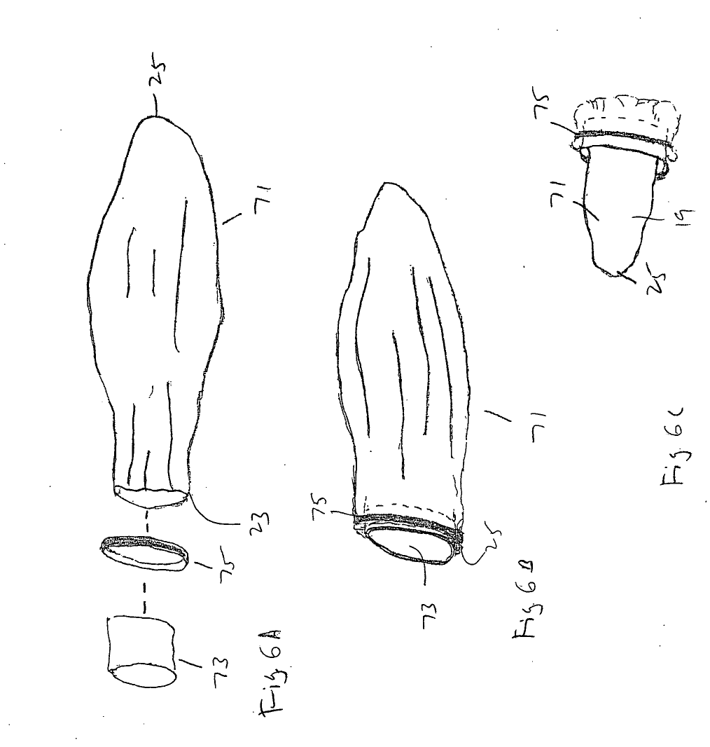

In FIGS. 1-3, there is shown the bag 13 of the present invention, in accordance with a preferred embodiment.

The bag 13 is inflatable and is seamless. The bag 13 can be used in several applications. One application is for lifting objects. The lifting bag 13 is inflatable and can be used to lift objects short distances. The lifting bag can also be used to pry objects apart. Typically, the bag is inserted under an object in a deflated condition and then inflated to lift the object. When the object is ready to be lowered, the bag is deflated.

Another application is for plugging the inside of pipes. The bag 13 is used as a plug and is inserted into the pipe in a deflated condition, inflated to block off the interior of the pipe and then deflated for removal.

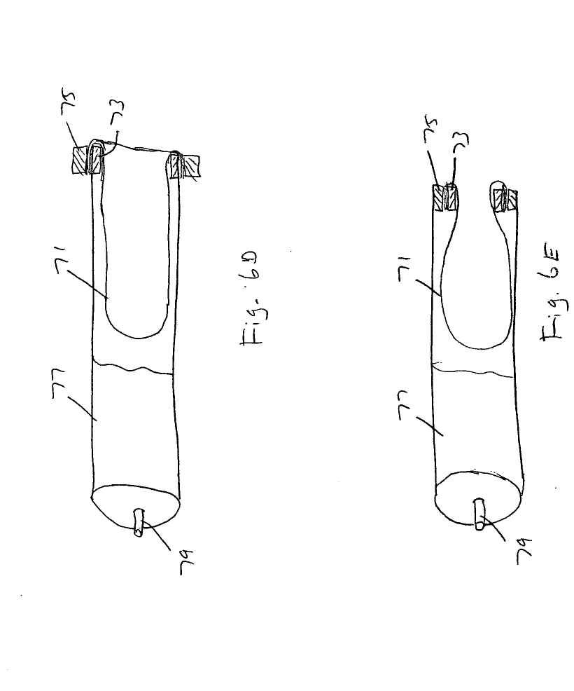

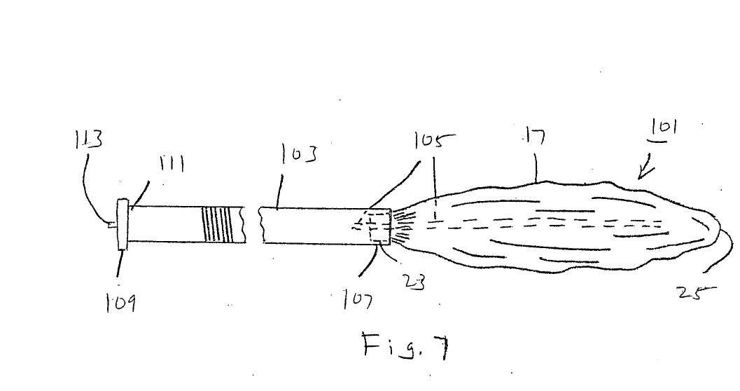

In the description that follows, the bag 13 will be described, with reference to FIGS. 1-3, followed by a description of use of the bag in lifting, with reference to FIGS. 4-5. Alternate embodiments are also described. Also, the bag used as a plug is described.

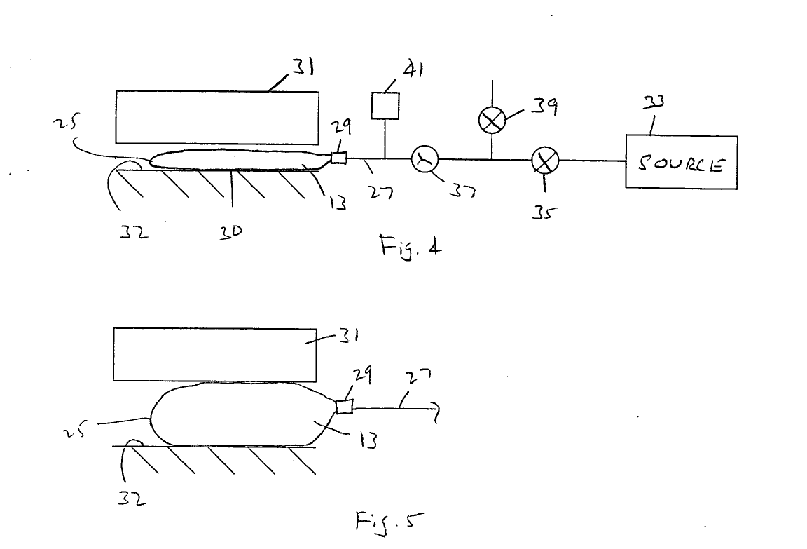

The lifting bag 13 is shown in FIGS. 1 and 2 in an unassembled condition. The bag is made of two layers (FIG. 1), namely an outer layer 17 and an inner layer 19. The outer layer 17 is made of fabric. In the preferred embodiment, the outer layer is made of woven p-aramid fibers, such as Kevlar or is made of Zylon (PBO-poly (p-phenylene-2,6-benzobisoxazole)). For purposes of this disclosure, Zylon is considered the equivalent of p-aramid. The material, weight, thickness, weave and so on are selected for the particular application of the lifting bag. For example, to lift an object weighing 6,000 pounds, the outer layer could be made of Kevlar 29, 1500 denier, 14.7 mils thick. The inner layer 19 is a waterproof or gas proof liner. In the preferred embodiment, the inner layer 19 is urethane of 8 mm thickness.

The inner and outer layers 19, 17 are cut into respective circular shapes of about the same diameter. The diameters of the inner and outer layers are determined by the desired outside diameter and height of the inflated bag 13. For example, a 48 inch diameter circle will make a bag that inflates to about 17 inches (maximum lifting height). This size bag will lift 4000 pounds about 9 inches at 40 psi inflation pressure.

The inner layer 19 is stacked on top of the outer layer 17, as shown in FIG. 1. Then, the outer edges 23 of the inner and outer layers 19, 17 are brought together around a fitting 21 as shown in FIG. 2. Thus, the outer edges 23 are at one end of the bag 13 of FIG. 2 and the center portions 25 of the outer and inner layers are at the other end. The one end 25 of the bag is closed by virtue of the construction of the bag. The other end 23 is gathered together so as to be around the fitting 21. In the preferred embodiment, the fitting 21 is a metal tube. The outer end of the tube 21 can be threaded or formed to receive another fitting or hose 27. Alternatively, a hose (not shown) can be inserted through the fitting 21 into the interior of the bag. The gathered end 23 and the fitting 21 are inserted into a metal ring or sleeve 29. The ring may be 1-2 inches or so in length. The ring 29 is pressed or crimped onto the end 23 of the bag to form an airtight seal around the fitting 21. In the preferred embodiment, the ring 29 is pressed by a hydraulic press. The crimping force should be sufficient to form an airtight seal, but not so much that the outer layer 17 is damaged. After crimping, an airtight seal is formed at the end 23 of the bag. The seal is formed between the ring 29 and the fitting 21, with the outer layer 17 interposed between the ring and the nipple.

Set screws 20 can be driven through the ring 29 into the fabric 17, 19. Also, a second sleeve or ring 22 can be positioned on the ring 29, toward the end 25. This second sleeve is crimped in place. The second sleeve is retained in place by the crimping, by the set screws and also by the enlarged outer end of the ring 29 and the fabric end 23. The set screws 20 are optional, as is the second sleeve 22. An outer sleeve 24 is placed over the second sleeve and extends so as to cover the second sleeve and the end 23. This outer sleeve 24 is for cosmetic purposes and can be painted after crimping. Potting compound 26 is placed inside of the outer sleeve 24 and around the tube 21.

FIGS. 4 and 5 illustrate the use of the bag 13 to lift an object 31, such as a vehicle. A source 33 of compressed air or gas is provided. In the preferred embodiment, the source 33 is a compressor 12 volt dc conventional compressors are commercially available and can plug into a vehicle's cigarette lighter. Another source of compressed gas is a bottle of compressed air.

The source 33 is connected to the bag 13 by way of the hose 27. An inflation valve 35 is provided in-line between the source 33 and the bag 13. There is also provided an in-line pressure gauge 37. A bleed line and valve 39 are provided on the hose 27.

In operation, the bag 13 is laid on its side 30 beneath the object 31 and the ground 32 as shown in FIG. 4. The bleed valve 39 is closed and the inflation valve 35 is opened. The source 33 provides compressed air or gas to the bag 13. The pressure can be monitored by the gauge 37. The bag is tested and designed to operate at a particular pressure, for example, 40 psi. The bag can in fact withstand higher pressures, however a factor of safety is provided. A pop off valve 41 can be provided so that if the bag is over inflated, by way of operator error, then the valve 41 will open and will cease the inflation to a potentially hazardous pressure.

As the bag 13 inflates, it contacts the object 31 and lifts it from the ground. When the bag has reached its operating pressure, the valve 35 is closed so as to cease inflating the bag. When the bag 13 is fully inflated, it becomes very rigid and stiff. The bag is quite durable and is puncture resistant. It can fit beneath the chassis of a vehicle underneath the axle. Bolts protruding into the bag will not puncture the bag. However, small pin like objects which can penetrate the outer layer 19 can puncture the bag and lead to loss of inflation pressure. When the bag is punctured in this manner, the bag will deflate slowly and safely.

When the object is ready to be lowered 31, the bleed valve 39 is opened and the air or gas escapes from the bag leading to a collapse of the bag and the lowering of the object 31.

The bag can be easily stored in the trunk of a car, in a toolbox, or other container. The bag is lightweight and easy to use. The bag can be left in a setup configuration, wherein the hose is already connected to the bag. Therefore, to use the bag 13, it is merely positioned beneath the object 31 and the source 33 is activated, such as plugging the compressor into the cigarette lighter. Therefore, the lifting bag is simple enough to use so that one does not extensive mechanical experience. When lifting vehicles, the bag should be positioned under a lifting point of the vehicle, as recommended by the vehicle's manufacturer.

The bag 13 can also be used to pry objects apart. For example, a vehicle damaged by a collision has bent or deformed metal pieces. The bag can be used to pry the pieces apart, such as for rescue of occupants, or for vehicle repair. To pry, the uninflated bag is inserted between two objects, namely the object that is to be moved and a fixed, sturdy object. Inflating the bag will cause the one object to move.

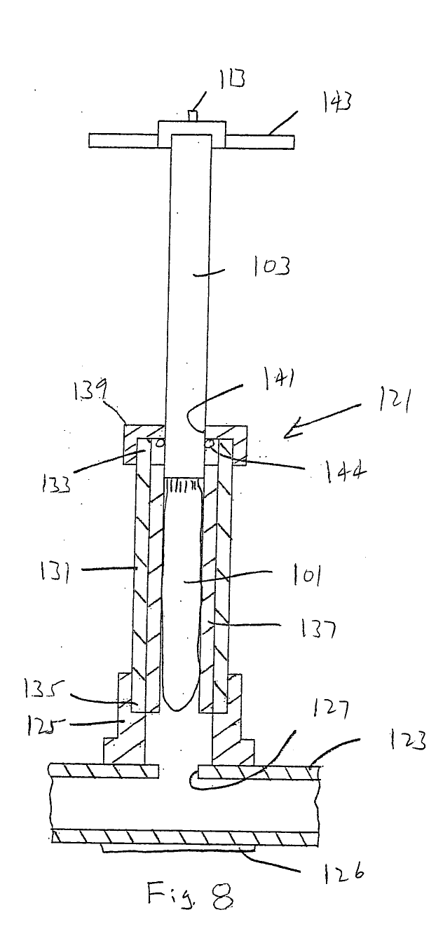

FIGS. 6A-6C show the bag 71 in accordance with another embodiment. This bag is similar to the bag 13, however bag 71 has a large opening. The bag is formed by crimping the open end 23 between an inner ring 73 and an outer ring 75, both of which are of relatively large diameter. The outer ring 75 is crimped onto the inner ring 73. The bag is shown in exploded view in FIG. 6A. FIG. 6B shows the assembled bag 71 with the ring 75 crimped.

The bag can be made self storing by passing the bag through the large opening, as shown in 6C. In this manner, the layers of the bag are inverted so the inner layer 19 is now outside and the outer layer 17 is now inside. FIGS. 6D and 6E show variations, where a protective pipe 77 is provided. In FIG. 6D, the inner ring 73 is pressed into one end of the pipe 77 to provide support. The open end or edges 23 of the bag 71 are then gathered around the sleeve end of the pipe 77. The outer ring 75 is then crimped around the end 23. In FIG. 6E, the bag 71 is made as described with respect to FIGS. 6A and 6B. The open end of the bag is then pressed into an end of the pipe 77 and the pipe end is crimped around the outer sleeve 75. The pipe 77 is metal and can be a tube. The bag 71 can be inverted so as to be located within the pipe 77. The other end of the pipe can be plugged and equipped with a fitting or nipple 79. Applying pressurized air to the fitting 79 ejects the bag from the pipe and inflates the bag. When not in use, the pipe protects the bag.

The lifting bag 13 can be used in a variety of applications. The bag can be used to pry objects apart. For example, in a vehicle crash, occupants may be trapped inside of the mangled vehicle body. Conventional techniques to extract the occupants involve hydraulic tools such as the “Jaws of Life”. The bag 13 can be used by emergency response personnel to pop open doors and other objects to open up the vehicle. Also, the bag can be used to pry burglar bars off of windows on structures so that occupants can egress the structure. The bag is put between the bars and the house frame and inflated. The bag can be inflated by a firefighter's self-contained breathing apparatus (SCBA), which has a tank of compressed air.

The use of the bag to plug a pipe will now be discussed.

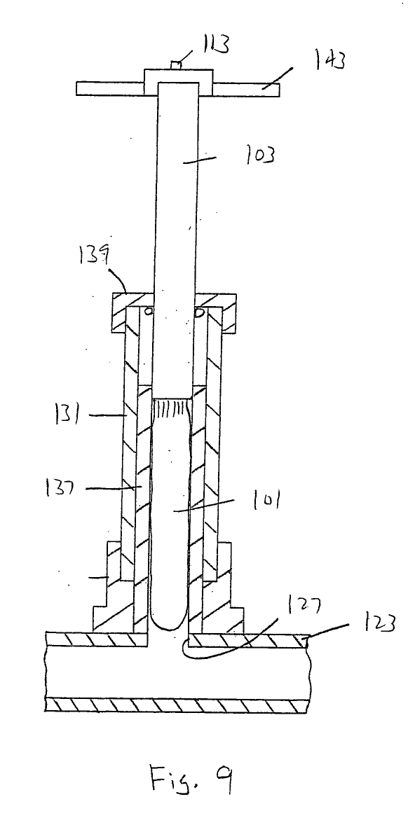

The bag 101 is shown in FIG. 7 with an injection tube 103. The material, weight, thickness, weave and so on of the outer layer 17 are selected for the particular application of the plug. For example, for water lines of 12 inches or less in diameter, the fabric is Kevlar A-200, 600 denier, 4.6 ounces per square yard, 8.4 mils thick. The inner layer 19 is a waterproof liner. In the preferred embodiment, the inner layer 19 is urethane of 8 millimeters thickness.

The outer edges 23 of the inner and outer layers 17, 19 are brought together to form the bag 101 as shown in FIG. 7. Thus, the outer edges 23 are at one end of the bag 13 of FIG. 7, and the center portions 25 of the outer and inner layers are at the other end. The one end 25 of the bag is closed by virtue of the construction of the bag. The other end 23 is gathered together around a metal sleeve 105 and inserted into an expanded end of the insertion tube 103. The insertion tube 103 is a metal pipe having exterior threads along its length. The sleeve 105 opens into the insertion portion 103.

Once the edges 23 are fully inserted into the insertion tube 103, the respective end 107 of the insertion tube is pressed or crimped onto the end of the bag to firmly couple the sleeve to the bag. In the preferred embodiment, the end 27 of the insertion tube 103 is pressed by a hydraulic press. This forms an airtight coupling around the end 23 of the bag.

A cap 109 closes off the other end 111 of the insertion tube 103 in an airtight manner. The cap 109 is equipped with an air valve fitting 113.

The bag 101 forms an airtight, inflatable plug. The fitting 113 allows the introduction and removal of air to and from the bag 101. Air passes through the fitting 113, into the tube 103, through the tube 105 and into the bag.

The bag 101 is seamless. Consequently, the bag can withstand high inflation pressures. Also, the bag can be more easily inserted into and retrieved from a pipe; a seam would tend to snag.

The use of the bag 101 as a plug will now be described.

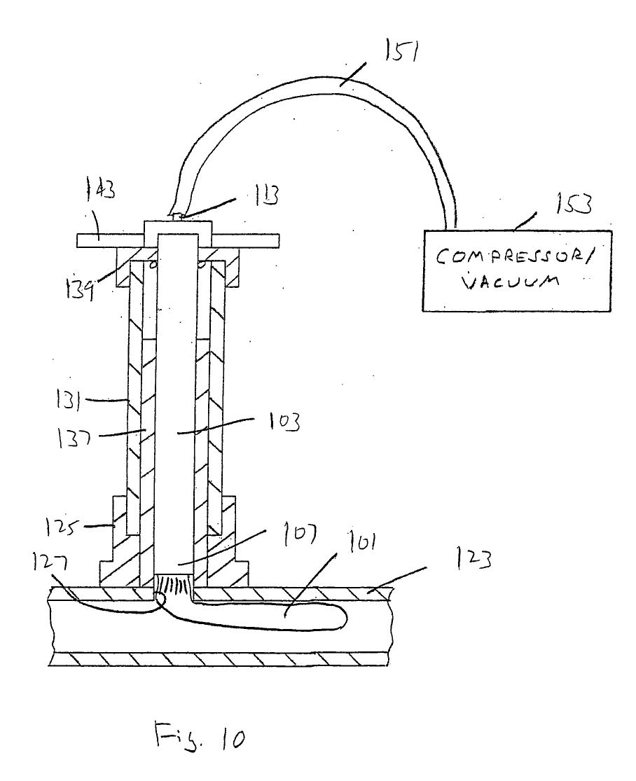

FIG. 8 shows an insertion tool 121 which is used to insert and extract the bag 101 into and from a pipe 123. In the description that follows, the terms “upper” and “lower” will be used with reference to the orientation of FIGS. 8-11. The tool need not be vertically upright as shown, but can be used at an orientation with respect to the pipe.

The tool 121 is designed for use with a conventional and commercially available corporation 125. The corporation 125 is secured around the pipe by a saddle or repair clamp 126 (shown only in FIG. 8). The corporation 125 receives a tapping tool (not shown) which taps a hole or opening 127 into the pipe 123. The corporation is a valve (not shown), which valve is located outside of the opening. The valve allows the opening to be isolated (valve closed) or accessed (valve open).

The tool 121 has an outer barrel 131 that has threads on its upper and lower ends 133, 135. The lower end 135 of the outer barrel 131 screws into the outer end of the corporation 125. An inner barrel 137 is inserted into the outer barrel 131. The bag 101 and a portion of the insertion tube 103 are located inside of the inner barrel 137. The bag 101 can move along the length of the inner barrel 137.

The bag 101 is moved inside of the inner barrel 137 by the insertion tube 103. The insertion tube 103 is received by a cap 139. The cap 139 is threaded onto the upper end 133 of the outer barrel 131. A set screw can be used to prevent the rotation of the cap 139 relative to the outer barrel 131 after installation. The cap 139 has a central opening 141, which opening is threaded to receive the insertion tube 103. The upper end of the insertion tube 103 has handles 143 extending radially therefrom. Alternatively, the cap 139 can have a hex nut, or other engagement surfaces or recesses for cooperating with a tool such as a wrench.

The tool 121 is typically assembled before installation onto the corporation 125. When installed, the tool is in the configuration of FIG. 8, wherein the bag 101 is fully retracted into the inner barrel 137.

In operation, the tool 121 is installed onto the corporation after the pipe 123 is tapped with an opening 127. The corporation valve is closed and the outer barrel 131 is inserted into the corporation 125.

To insert the bag 101, the corporation valve is opened. A seal 144 is provided between the cap 139 and the insertion tube 103. The insertion tube 103 is rotated by the handles 143 so as to move the tube 103 closer to the pipe 123. The tube 103 rotates relative to the cap 139.

As the bag 101 moves closer to the pipe, the inner barrel 137 likewise moves inside of the outer barrel 131. The movement of the inner barrel 137 toward the pipe is arrested by the pipe 123 (see FIG. 9). The inner barrel 137 serves as an adapter. The inside diameter of the inner barrel is the same inside diameter as the pipe opening 127. The inner barrel 137 maintains alignment of the bag 101 with the opening 127.

As the tube 103 is moved into the remainder of the insertion tool 121, the bag 101 is moved down the inner barrel 137, through the opening 127 and into the pipe 123 itself (see FIG. 10). In a water pipe, the pipe is under pressure from the water located therein. The tube 103 and cap 139 arrangement allows sufficient force to be applied to overcome the water pressure and insert the bag 101 into the pipe 123. The length of the tube 103 is such that the lower end 107 remains outside of the pipe 123.

While the bag 101 is uninflated and fully inserted, it is likely be moved around inside of the pipe due to the flow of water inside of the pipe. The outer layer 17 is tough and can withstand the forces applied to the plug.

An air hose 151 is connected to an air compressor 153 and to the fitting 113, as shown in FIG. 10. Compressed air is provided to the tube 103 and to the bag 101, thereby inflating the bag. When fully inflated, the bag 101 occludes the inside diameter of the pipe 123, sealing the pipe, as shown in FIG. 11. In practice, the seal may not be entirely watertight; a small amount of water may leak past the plug.

The bag 101 can be inflated with air or with fluid such as water.

In the preferred embodiment, the bag 101 is inflated to 100 psi or greater and can be inflated up to 150 psi. The bag is able to withstand these large pressures because there is no seam in the inner and outer layers. Seams are typically the weakest locations in fabric. Furthermore, the seamless bag is more easily inserted into and retrieved from the pipe; a seam would tend to snag on the opening 127.

While the pipe 123 is plugged, repairs or maintenance can be made to the pipe.

After the repairs or maintenance on the pipe are completed, the bag can be removed from the pipe by reversing the steps for inserting the bag. The bag 101 is deflated by releasing the interior air. Further, in order to ease the retrieval of the plug through the opening 127 of the pipe, a vacuum is applied to the bag to remove as much air as possible and shrink the bag. Once the bag is deflated, the tube 103 is withdrawn from the cap 139 and the bag is pulled out of the pipe 123 and into the interior barrel 137, as shown in FIG. 8. The corporation valve is then closed and the insertion tool is removed.

One advantage of the plug is the seamless construction of the bag 101. The seamless bag can withstand greater inflation pressures, allowing a more complete plugging of the interior of the pipe. Also, the seamless bag is more easily installed and retrieved through a cooperation and pipe opening.

Another advantage is that the bag is easily adaptable to pipes of different sizes. A single bag can be used on a range of pipe inside diameters. Also, the design allows bags to be easily fabricated for smaller or larger pipes. For example, a bag that is sized for a twelve-inch pipe can be used on a smaller diameter pipe, such as a six-inch pipe. In this type of insertion, the full length of the bag is typically not inserted into the smaller pipe.

Furtherstill, the plug and insertion tool are reusable. The insertion tool undergoes little wear during use. The bag itself may be worn with each use. If the interior of the pipe is heavily calcified, then the outer layer may exhibit more wear than when used inside of a cleaner pipe. Nevertheless, the bag can be used for at least several plugging operations and possibly more if the interior of the pipe is relatively clean.

Use of the plug and the insertion tool provides an inexpensive manner to block a pipe. The equipment itself is relatively inexpensive and the plug is simple to install, reducing installation and down time. Use of the plug will result in a savings of time and money. The plug can used to: repair pipe leaks; repair or remove a broken gate valve; install a tie-in to an existing main pipe without depressurizing the main pipe; and reduce the chances of contamination in the main pipeline by restricting the de-pressurized working areas.

The plug of the present invention can also be used on other types of pipes besides water pipes, such as sewer pipes. In a sewer pipe application, the tube 103 is shortened to form a collar. The tube seals off the open end 23 of the bag and provides for air access to the interior of the bag. Because sewer pipes are unpressurized, no seal 144 is required.

Other insertion mechanisms can be used to insert the bag 101 into the pipe 123.

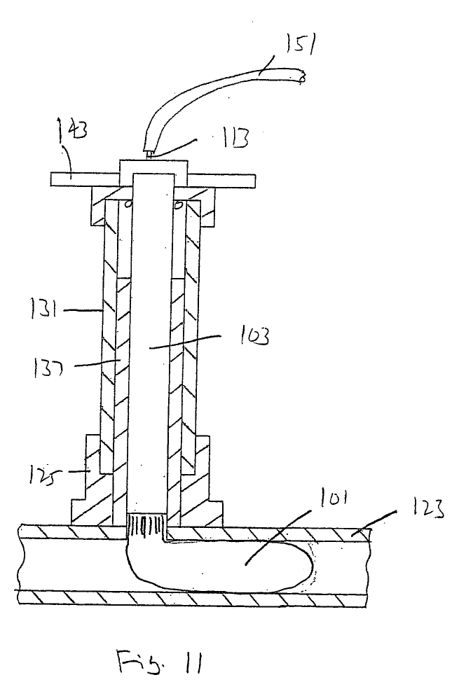

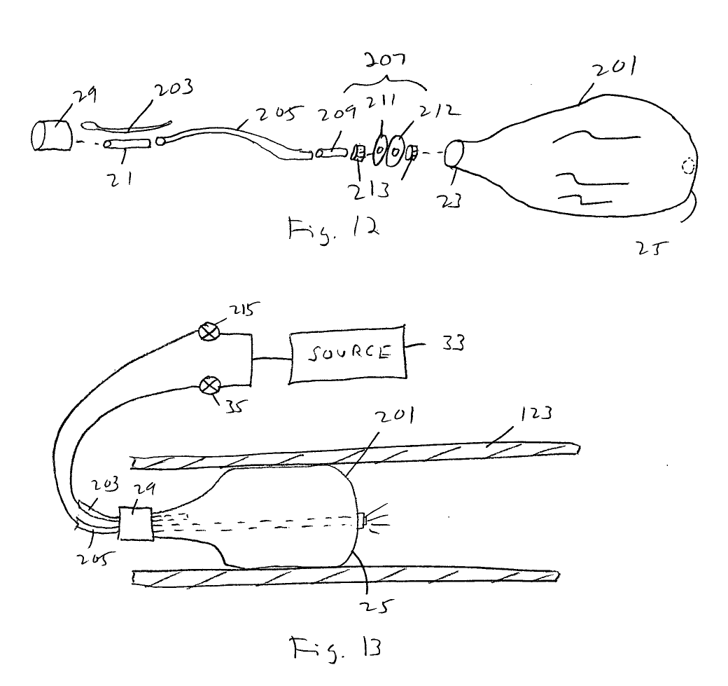

FIGS. 12 and 13 show the plug 201 in accordance with another embodiment. The plug 201 allows air or water to flow therethrough, even after the plug has been fully inflated. For example, once the plug is inflated, and after repairs have been made to the pipe, the repair can be pressure tested, without unplugging the pipe.

The bag 201 has two lines 203, 205. One line 203 inflates the bag 201. The other line 205 leads through the bag to the normally closed end 25. The line 25 penetrates the bag at the normally closed end 25 by a fitting 207 made of a threaded tube 209. In accordance with one embodiment, the fitting 207 comprises an inside washer 211, an outside washer 212 and nuts 213 are provided on the tube. The bag layers 17, 19 are interposed between the washers 211, 212. The outer sleeve 29 at the other end 23 can be coupled to an insertion tool.

In operation, the plug 201 is inserted into the pipe 123 and inflated through the line 203, by way of source 33 and valve 35. Air or water can be passed through the inflated plug by the fitting 207 to pressure test the pipe by way of source 33 and valve 215; plugs are provided at two locations in the pipe with the plugged space being pressure tested. A single source 33 can be used if the same type of fluid is passed through the lines 203, 205. If two different types of fluids are used (e.g. gas in line 203, liquid in line 205), then two sources are used. To remove the plug 201, the line 205 is depressurized, followed by the line 203 to deflate the plug.

The foregoing disclosure and showings made in the drawings are merely illustrative of the principles of this invention and are not to be interpreted in a limiting sense.

1. An apparatus for expanding between two points, comprising:
a) an inner layer that is gas proof;
b) an outer layer that is made of a woven material;
c) the inner and outer layers adjacent to one another so as to form a flexible wall having at least one edge around a central portion, the flexible wall being seamless;
d) the edge being gathered and located around a tube so as to form an inner chamber that is lined by the inner layer;
e) a sleeve located around the gathered edge and being crimped in place to secure the gathered edge, the tube providing communication between the inner chamber and an exterior of the bag;
f) the bag having two ends when deflated, the tube being located at one end and the central portion being located at the other end.

2. The apparatus of claim 1, wherein the outer layer comprises p-aramid material.

3. The apparatus of claim 1, wherein the inner and outer layers are separate from each other.

4. The apparatus of claim 1, wherein the sleeve is a first sleeve, the first end having a free end and a bag end, the bag further comprising a second sleeve being shorter in length than the first sleeve, the second sleeve being located around the first sleeve so as to leave the free end of the first sleeve exposed.

5. The apparatus of claim 1, wherein the inner and outer layers are circular when laid flat.

6. The apparatus of claim 1, further comprising an air compressor and a relief valve connected to the tube.

7. The apparatus of claim 1, further comprising a second tube that extends from the one end through the inner chamber and through the wall at the other end.

8. The apparatus of claim 1 further comprising a pipe, with the inner and outer layers stowed inside of the pipe when uninflated and an end of the pipe being crimped about the gathered edge.

9. A method of constructing an inflatable, expandable bag, comprising the steps of:
a) providing a flexible material having a gas proof liner and a woven protective layer, the material having a central portion and an edge at a perimeter of the material;
b) wrapping a tube with the edge so as to encircle the tube and form a bag with an inner chamber that is lined by the gas proof liner, the protective layer being on an exterior of the bag;
c) placing a sleeve over the material so that the material is interposed between the tube and the sleeve;
d) crimping the sleeve onto the material.

10. The method of claim 9, wherein the sleeve is a first sleeve, further comprising the steps of:
e) placing a second sleeve over the crimped first sleeve so as to leave uncovered a portion of the first sleeve, the second sleeve located between the uncovered first sleeve portion and the central portion;
f) crimping the second sleeve.

11. A method of moving an object, the object being spaced from a reference by a distance, comprising the steps of:
a) providing a seamless inflatable bag made of a protective outer material having a central portion and edges, with the edges located around an access port, with the access port being at one end of the bag and the central portion being at another end of the bag, the edges being secured around the access port by a crimped sleeve;
b) locating the bag between the object and the reference so that the access port is accessible and the outer material of the bag will contact the object and the reference upon inflation of the bag;
c) inflating the bag at the access port so that the bag outer material contacts both the object and the reference;
d) continuing to inflate the bag until the distance between the object and the reference increases.

12. The method of claim 11, wherein the step of providing a seamless inflatable bag further comprises the step of locating the access port on an end of the crimped sleeve and the step of locating the bag between the object and the reference further comprises locating the bag so that sides of the bag that extend between the ends will contact the object and the reference upon inflation of the bag.

13. A method of plugging a pipe, the pipe having an inside diameter, comprising the steps of:
a) providing a seamless inflatable bag made of a protective outer material having a central portion and edges, with the edges located around an access port, with the access port being at one end of the bag and the central portion being at another end of the bag, the bag having sides extending between the ends, the edges being secured around the access port by a crimped sleeve;
b) inserting the other end of the bag into the pipe;
c) inflating the bag through the access port so that the bag sides contact the pipe inside diameter, thereby plugging the pipe.

14. The method of claim 13, wherein the access port is a first access port, further comprising the step of providing a second access port which communicates with a passage extending to the other end of the bag and after plugging the pipe with the inflated bag, providing fluid to the pipe through the second access port.
